(19) United States
(12) Patent Application Publication
(10) Pub. No.: US 2005/0069403 A1
(43) Pub. Date: Mar. 31, 2005

(54) Trailer with independent displaceable dual beds

(76) Inventor: Stephen R.B. Holman, Tangier (CA)

Correspondence Address: Ray L. Weber;Renner, Kenner, Greive, Bobak, Taylor & Weber, Fourth Floor, First National Tower, Akron, OH, 44308-1456, US

(21) Appl. No.: 10/938,279

(22) Filed: Sep. 10, 2004

(30) Foreign Application Priority Data
Sep. 10, 2003 (CA) 2,440,426

(51) Int. Cl. B60P 1/04

(52) U.S. Cl. 414/482

(57) ABSTRACT

A trailer for towing motorized vehicles behind a tow vehicle, the trailer comprising an undercarriage, at least one axle and an attachment mechanism for attaching the trailer behind the tow vehicle, the trailer further comprising first and second independently displaceable bed sections mounted longitudinally adjacent to one another on the undercarriage, each of the bed sections being displaceable away from each other towards respective sides of the undercarriage, the bed sections having a forward end that displaces substantially outwardly towards the respective sides so as to allow sufficient clearance from the tow vehicle, allowing motorized vehicles to be offloaded in a forward direction.

### FIELD OF THE INVENTION

The present invention relates generally to a dual bed trailer having two adjacent beds, each provided with a means to displace the majority of the front end of the beds outboard of the undercarriage to permit a motorized vehicle to be offloaded by being driven in a forward direction to one side of a tow vehicle.

### BACKGROUND OF THE INVENTION

The use of a trailer to transport motorized vehicles presents certain challenges, especially when dealing with vehicles that are not customarily used in reverse. Examples of these vehicles include snowmobiles and motorcycles. To accommodate these types of vehicles, a number of trailer designs are known in which the platform supporting the vehicle is rotatable a full 90° or 180°. In general, these designs allow a vehicle to be loaded and unloaded with respect to a trailer without having to reverse at any point in the operation. This is accomplished by rotating the entire support platform to either the side or rear of the trailer, thus allowing the vehicle to be driven off, instead of backed-off the trailer. Examples of trailers providing a rotatable platform for facilitating forward off-loading are disclosed in U.S. Pat. No. 3,720,336, U.S. Pat. No. 4,109,809, U.S. Pat. No. 5,259,720, U.S. Pat. No. 5,393,191, Canadian Patent No. 1,040,229 and Canadian Patent Application No. 2,229,503.

In the various designs currently available, the platform supporting the vehicle is rotatable and in some cases tiltable. Unfortunately, when the platform is configured to support two vehicles (i.e. two snowmobiles or motorcycles), both vehicles are subjected to being moved, regardless of whether only one is to be unloaded. The fact that the entire platform is rotated presents unique engineering challenges due to the fact that the pivot point for the platform is under extreme load. This presents a particular weakness in these previous designs.

There is clearly a significant need for a trailer that supports two vehicles, where each vehicle can be loaded and unloaded independently of the other. To accomplish this, the trailer must have bed sections that are completely independent of each other, so as to allow loading and unloading of motorized vehicles without the need for coordinating the position of the other.

### SUMMARY OF THE INVENTION

A trailer with independent displaceable dual beds, in accordance with an aspect of this invention, allowing for each bed section to be displaced to permit a motorized vehicle to be offloaded by being driven in a forward direction to one side of a tow vehicle. The trailer with independent displaceable dual beds comprises an undercarriage supporting individual dual beds, the trailer having means to displace the majority of the front end of each of the bed sections outboard of the undercarriage. The adjacent bed sections are offsettable away from each other towards respective sides of the undercarriage. In a stowed position, the front end of each of the two adjacent bed sections are oriented generally in the forward facing direction. During deployment, each of the two adjacent bed sections may be independently displaced laterally to the undercarriage to position said majority of the front end outboard of the undercarriage. This permits the motorized vehicles to be unloaded in the forward direction towards the respective side of the tow vehicle.

According to an aspect of the present invention, there is provided a trailer for towing motorized vehicles behind a tow vehicle, said trailer comprises:
an undercarriage having a forward end and a rear end;
at least one axle on said undercarriage for mounting of wheels for supporting said undercarriage;
an attachment mechanism extending from said forward end of said undercarriage for attaching said trailer behind said tow vehicle; and
first and second independently displaceable bed sections mounted longitudinally adjacent to one another on said undercarriage, each of said bed sections being displaceable away from each other towards respective sides of said undercarriage, said bed sections having a forward end that displaces substantially outwardly towards said respective sides so as to allow sufficient clearance from said tow vehicle, allowing said motorized vehicles to be offloaded in a forward direction.

### BRIEF DESCRIPTION OF THE DRAWINGS

FIG. 1 is a plan view of a preferred embodiment of the current invention.

FIG. 2A is an exploded plan view of the left bed section of the embodiment shown in FIG. 1.

FIG. 2B is an embodiment of the friction reducing means for the pivot points in the embodiment shown in FIG. 1.

FIG. 2C is an alternate embodiment of the friction reducing means for the pivot points in the embodiment shown in FIG. 1.

FIG. 2D is another embodiment of the friction reducing means for the pivot points in the embodiment shown in FIG. 1.

FIG. 3A is an elevation view of the embodiment shown in FIG. 1.

FIG. 3B is an enlarged elevation view of the second brace member of the embodiment shown in FIG. 1.

FIG. 3C is an enlarged elevation view of the locking mechanism of the embodiment shown in FIG. 1.

FIG. 3D is an elevation view of an alternate embodiment of the railing configuration for the trailer of the current invention.

FIG. 4 is a plan view of an alternate undercarriage for the trailer of the current invention.

FIG. 5A is an elevation view of the undercarriage of the embodiment shown in FIG. 1.

FIG. 5B is a plan view of the rear ramp assembly.

FIG. 5C is an elevation view of the rear ramp assembly.

FIG. 5D is a rear view of the undercarriage showing the storage bay for the rear ramp assembly.

FIG. 6A is a plan view of an alternate embodiment of the current invention using hydraulics to displace the bed sections.

FIG. 6B is a plan view of the embodiment shown in FIG. 6A showing the trailer in a deployed position.

FIG. 6C is a plan view of another alternate embodiment of the current invention using a track assembly to facilitate displacement of the bed sections.

FIG. 6D is a plan view of the embodiment shown in FIG. 6C showing the trailer in a deployed position.

FIG. 6E is an end view of a track assembly for use in guiding the embodiment shown in FIG. 6C.

### DETAILED DESCRIPTION OF THE PREFERRED EMBODIMENTS

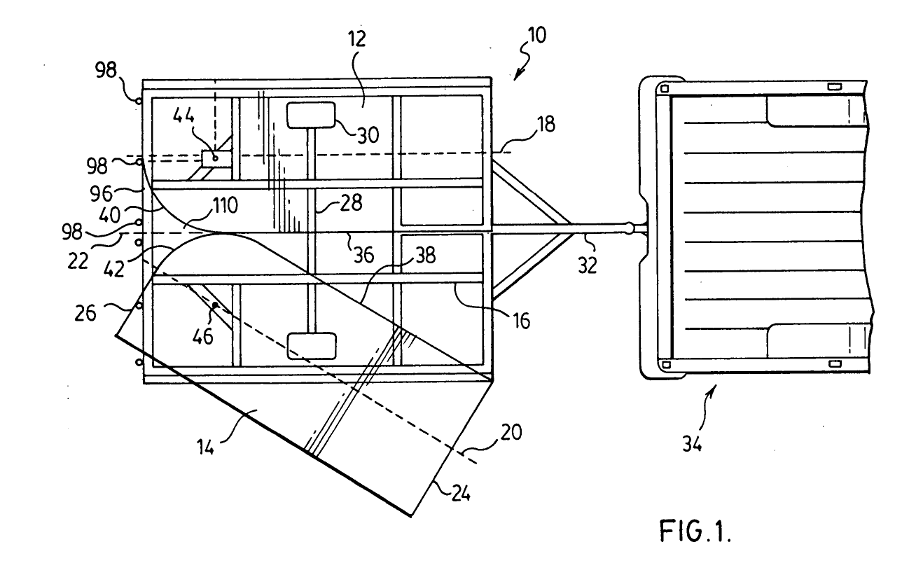

As shown in FIG. 1, the present invention relates generally to a dual bed trailer 10 having two adjacent bed sections 12, 14, the trailer 10 being provided with a means to displace the majority of the front end of each of the bed sections 12, 14 outboard of the undercarriage 16 to facilitate unloading of motorized vehicles. The adjacent bed sections 12, 14 are offsettable away from each other towards respective sides of the undercarriage 16. In a stowed position, the axis 18, 20 of each of the two adjacent bed sections 12, 14 is aligned generally parallel with the longitudinal axis 22 of the undercarriage 16. During deployment, each of the two adjacent bed sections 12, 14 may be independently displaced away from the longitudinal axis 22 of the undercarriage 16, where the front end 24 is displaced to a greater extent than the rear end 26. This permits the motorized vehicles to be unloaded by being driven in the forward direction towards one side of the undercarriage, thus facilitating a more controlled removal of potentially difficult to maneuver cargo, such as snowmobiles and motorcycles. While being very suitable for motorized vehicles, it can be appreciated that a trailer of the present invention may be suitable for a range of other uses, such as in the lawn-care industry, However, for explanation purposes, the operation of the trailer will be discussed with respect to motorized vehicles.

In the embodiment shown in FIG. 1, each of the bed sections 12, 14 are independently pivotable away from each other to displace the majority of the front end 24 of each of the bed sections 12, 14 outboard of the undercarriage 16 to facilitate unloading of motorized vehicles. In addition to the pivotable bed sections 12, 14 and undercarriage 16, the trailer 10 comprises at least one axle 28 with wheels 30, and an attachment mechanism 32 (i.e. an attachment arm comprising a tongue for cooperation with a corresponding mating mechanism on the tow vehicle) for pulling the trailer behind a suitable tow vehicle 34.

To allow each bed section 12, 14 to pivot independently of each other, each bed section is dimensioned along the rear portion of adjacent inside edges 36 and 38 with a cutout to permit unrestricted movement from a stowed position to a deployed position. In the embodiment shown in FIG. 1, the cutout is formed as radiused curves 40 and 42, but one can appreciate that any suitable cutout profile can be used, such as an angled cutout forming a triangular profile. Continuing with the embodiment shown in FIG. 1, each bed section is pivotably fixed to the undercarriage at pivot points 44 and 46 that correspond to the centre of rotation defined by the radiused curves 40, 42, respectively.

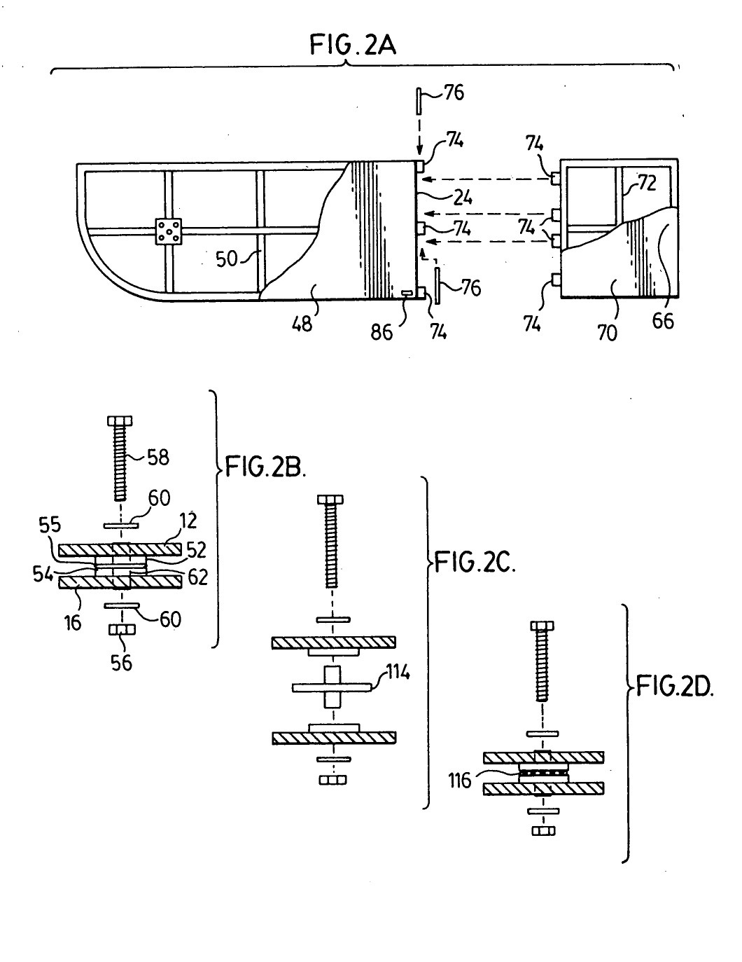

Shown in FIG. 2A with respect to the left bed section 12, each bed section comprises a platform 48 supported underneath by an open-lattice frame 50. While square steel tubing is a preferred material for frame construction, it can be appreciated that one skilled in the art may choose to utilize alternate suitable materials for frame members such as aluminum, stainless steel, and composites such as fiberglass reinforced steel and synthetics such as carbon fibre, and that such substitutions are intended to be encompassed by the present invention. As described above, each of the bed sections 12, 14 is dimensioned with a cutout (i.e. radiused curve 40, 42) to facilitate independent pivoting of each of the bed sections. At the respective pivot points 44, 46 pivoting of each of the bed sections 12, 14 relative to the undercarriage 16 may be facilitated by a friction reduction means. For example, as shown in FIG. 2B with respect to pivot point 44, there can be provided two mating surfaces, a first mating surface 52 being attached to the bed section 12, and a second mating surface 54 attached to the undercarriage 16, where between the two surfaces 52, 54, grease 55 can be applied so as to reduce friction upon rotation relative to one another. To maintain attachment of the bed section 12 to the undercarriage 16 at the respective pivot point, a suitable fastener is used. One possible arrangement is shown in FIG. 2B where a nut 56, bolt 58 and suitable washers 60 are used with a cylindrical spacer 62 positioned therebetween to prevent excessive compression forces upon the pivoting mating surfaces.

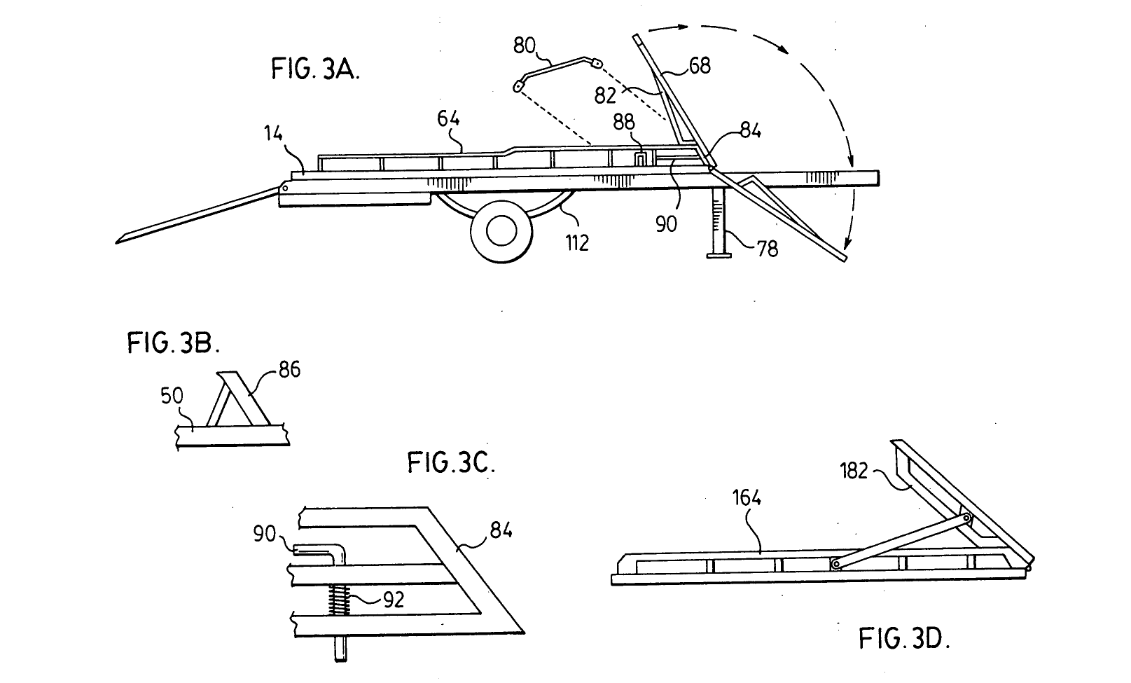

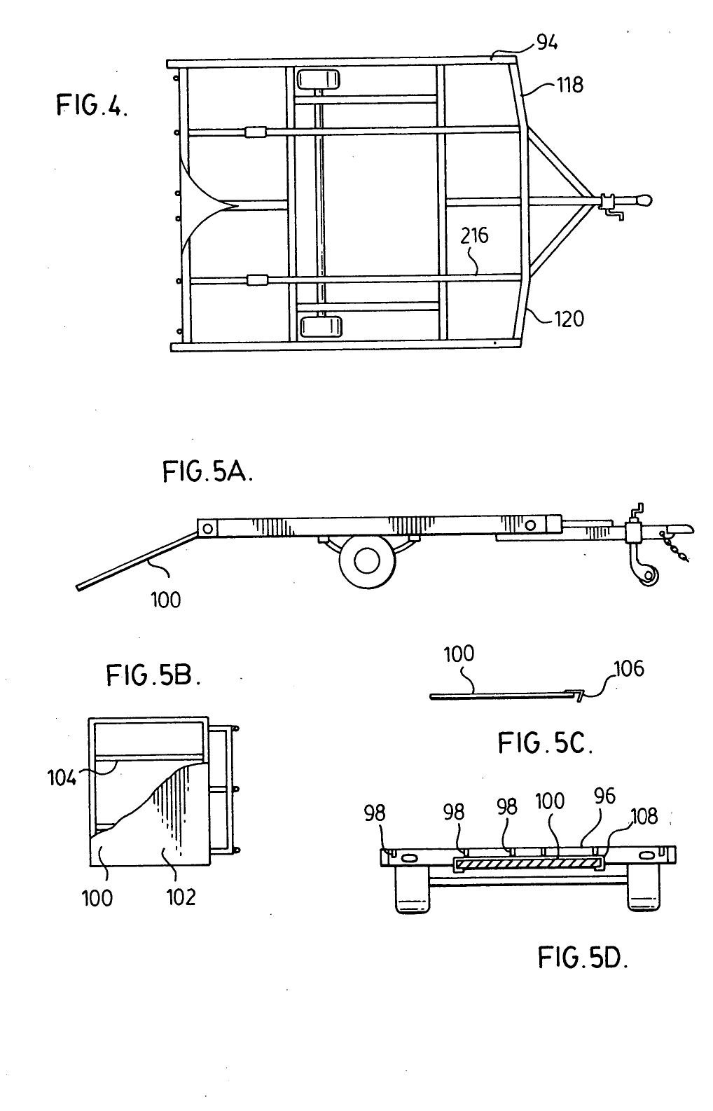

Each bed section is provided with an outside railing 64 to ensure retainment of transported vehicles. In the embodiment shown in FIG. 3A, showing the right bed section 14, the outside railing 64 is an open lattice railing made from square steel tubing. It is understood that the use of square steel tubing is just one embodiment and that the outside railing can in fact be configured in various forms using alternate suitable materials. Each of the bed sections 12, 14 is adapted to receive a front ramp assembly 66, 68 (66 shown with respect to left bed section 12 in FIG. 2A, 68 shown with respect to right bed section 14 in FIG. 3A) for unloading vehicles. Each of the front ramp assemblies 66, 68 are of similar construction as the bed sections 12, 14, each ramp comprising a platform 70 supported by a frame 72 (as shown in FIG. 2A with respect to front ramp assembly 66). As shown in FIG. 2A, the front ramps are mounted on the forward end 24 of the respective bed section by means of hinges comprising offset tubular sections 74 and pins 76. As shown in FIG. 3A, the front ramp assemblies are movable from a stowed position to an unloading or deployed position. In the deployed position, the bed sections 12, 14 may utilize removable support bar 78 to provide additional stability to the forward end 24 of the bed section during unloading of motorized vehicles. To maintain each of the front ramp assemblies in the stowed position, a locking bar 80 is positioned between a section of railing 82 provided on each of the front ramp assemblies and the outside railing 64 of each of the bed sections. The locking bar 80 is adapted to be retained in position by means of removable pins received within corresponding holes located on each respective railing sections 64, 82. When the front ramp assemblies are in the stowed position, they are prevented from falling inwards by suitable braces. The outside railing 64 of each of the bed sections is dimensioned with brace member 84 to support the front ramp as shown in FIG. 3A. The railing section 82 of each of the front ramp assemblies is likewise adapted to permit the front ramp to engage brace member 84 provided by railing section 64. Additionally, each of the bed sections comprise a second brace member 86 (see FIG. 2A and FIG. 3B) attached to the frame 50 along the inside edge proximal the forward end. On each bed section 12 and 14, there is provided suitable anchors for locking the transported vehicles in place. FIG. 3A shows an inverted U-shaped member 88 attached proximal the outside edge of the frame 50. It can be appreciated that while FIG. 3A shows one anchor point, the bed sections 12, 14 can in fact incorporate a plurality of anchor points as deemed to be necessary. To prevent the bed sections 12, 14 from displacing with respect to the undercarriage 16, each bed section is provided with a suitable locking mechanism. Shown in FIG. 3A is a retractable L-shaped pin 90 mounted on the topside of the frame proximal the outside edge towards the forward end. FIG. 3C shows an enlarged view of the locking mechanism where provided is the L-shaped pin 90 biased towards a downward locking position by spring 92. The L-shaped pin registers within a corresponding hole 94 (see FIG. 4) in the undercarriage, thus preventing unwanted displacement of the bed section during transport.

As shown in FIG. 1, the undercarriage 16 comprises an open-lattice frame for supporting both bed sections 12 and 14, at least one axle 28 for mounting wheels 30, and an attachment mechanism 32 for supporting the appropriate trailer-hitch and gear. Along the rear edge 96 of the undercarriage 16, there is provided a plurality of mounting holes 98 (see FIGS. 1 and 5D) for placement of a loading ramp 100 (see FIGS. 5A to 5D). Loading ramp 100 is dimensioned to detachably fit each bed section separately and while the trailer can be provided with two separate loading ramps, in general, only one loading ramp is provided. The provision of a single vehicle ramp is to facilitate easy manipulation and storage of the loading ramp as it is completely detached following use. Similar to bed sections 12, 14 and front ramps 66, 68 the loading ramp 100 comprises a platform 102 supported by an open-lattice frame 104, as shown in FIG. 5B. The loading ramp 100 also comprises a plurality of offset pins 106 (see FIG. 5C) that register in mounting holes 98 for secure attachment to the undercarriage 16 during loading of vehicles. On the underside of the undercarriage 16, a storage bay 108 is provided for the loading ramp 100 when not in use (see FIG. 5D).

As described above, each bed section is dimensioned along the rear portion of adjacent inside edges 36, 38 with a cutout to permit unrestricted movement from a stowed position to a deployed position. In the region defined by the cutout, a plate may be inserted to fill the gap. In cases where the cutout in angular (i.e. triangular cutouts), the plate would be removable so as to provide space for each of the bed sections to move. In the embodiment shown in FIG. 1, a fixed plate 110 is provided to fill in the gap created by the two radiused bed sections. The plate 110 is dimensioned to allow unobstructed movement of each bed section 12 and 14 relative to one another, and relative to the plate 110 itself.

To facilitate displacement of the bed sections, especially under load conditions, a number of friction reduction means may be implemented. For example, the topside of the various structural members of the undercarriage can have Teflon™ strips applied thereto at positions where friction between the undercarriage 16 and the bed section 12, 14 is likely to occur. Alternatively, friction may be reduced using a series of ball races positioned on the undercarriage (not shown).

In addition to the various operational components described thus far, the dual bed trailer of the current invention it outfitted with industry standard components for complete and proper trailer operation. As shown in FIG. 1, the dual bed trailer 10 comprises at least one axle 28 for mounting wheels 30. A suspension system may or may not be used in mounting the axle 28 to the undercarriage 16. In the embodiment shown in FIG. 3A, a leaf-spring suspension 112 has been implemented for retention of the axle 28. The trailer 10 is also fitted with running/brake lights and license identification plates in accordance with local laws and regulations. The trailer may be provided with mounting posts for spare tires as well as storage compartments (not shown).

To load a vehicle (i.e. snowmobile) onto the trailer 10, the loading ramp is removed from storage bay 108 and positioned into place at the rear 96 of the bed section ensuring engagement between offset pins 106 (see FIG. 5C) and mounting holes 98 on undercarriage 16. To ensure that the bed section does not displace during loading, or subsequent transport, the locking mechanism must be engaged. This requires L-shaped pin 90 of the bed section to register in corresponding hole 94 on the undercarriage 16. Once the snowmobile is loaded onto the bed section, the snowmobile is retained in position using the anchor points provided. During transport, loading ramps 66, 68 are in the stowed position and locked in place using locking bar 80. To unload the snowmobile from the trailer, the trailer is parked, and the locking mechanism is disengaged. The bed section is then displaced where the majority of the front end of the bed section is positioned outboard of the respective side of the undercarriage. The appropriate front ramp assembly is unlocked, lowered to the ground and locked into position. If required, a support bar can be utilized to add additional support to the front end of the bed section. With the front ramp deployed, the snowmobile can be unlocked from the anchor points and driven forwardly off the trailer.

As an alternative to the friction reduction means shown in FIG. 2B where grease 55 is used between two mating surfaces 52, 54 of the bed section 12 and undercarriage 16, alternate embodiments may use a low friction washer 114 (i.e. Teflon), as shown in FIG. 2C, or a suitable bearing arrangement 116, as shown in FIG. 2D.

Shown in FIG. 3D is an alternate configuration of the outside railing 164 and railing section 182 for the trailer described above. In this embodiment, the outside railing 164 and railing section 182 is configured without stepdowns and are aligned generally parallel to the respective base to which they are attached.

Shown in FIG. 4 is an alternate embodiment of the undercarriage 216 where there are slight variations in the positioning of the main structural members as compared to the embodiment shown in FIG. 1. In addition, this embodiment includes tapered portions 118,120 to provide extra clearance for the bed sections when being displaced to the deployed position.

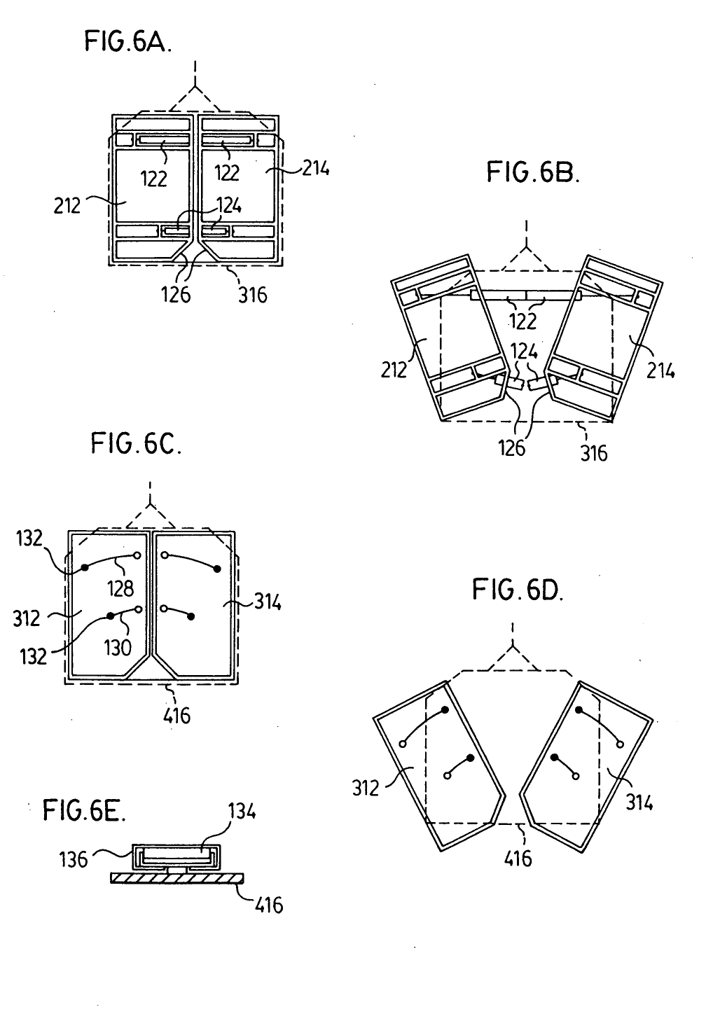

Shown in FIG. 6A is an alternate embodiment of the displacement means, where hydraulic cylinders 122, 124 are used to displace each of the bed sections. Each of the bed sections 212, 214 are dimensioned with triangular cutouts 126 to provide proper clearance in accordance with the extent of the displacement of each of the bed sections when undergoing deployment. As shown in FIG. 6B, the bed sections 212, 214 are displaced with the forward hydraulic cylinder 122 extending further than the rear cylinder 124, thus displacing the forward end of the bed sections 212, 214 outwardly relative to one another and the undercarriage 316. The forward hydraulic cylinder 122 is shown fixed to the undercarriage 316, but it is not beyond the scope of this invention to provide a deployment system where both forward 122 and rear hydraulic cylinders 124 are movable with respect to the undercarriage 316.

It can also be appreciated that deployment of the bed sections can be facilitated by an arrangement where movement of the bed section is defined and guided by an arced track assembly. In the embodiment shown in FIG. 6C, the bottom surfaces of each of the bed sections 312, 314 are adapted with arced forward channel 128 and arced rear channel 130 that mate with a corresponding pin or roller 132. As shown in FIG. 6B, the forward channel 128 displaces the forward end of the bed section to a greater extent than the rear channel 130, thus displacing the forward end of the bed sections 312, 314 outward relative to one another and the undercarriage 416. The forward and rear channels 128, 130 are arced about the same center point to as to achieve uniform spacing between the two channels. FIG. 6C shows one option for the track assembly, where roller 134 is mounted on the undercarriage 416 and is retained in a channel 136 exposed on the underside of the bed section.

Aside from the hydraulic mechanism disclosed earlier, it can be appreciated that a mechanical (i.e. crank) or motorized component could be implemented to assist in the displacement of the bed section.

Although preferred embodiments of the invention have been described herein in detail, it will be understood by those skilled in the art that variations may be made thereto without departing from the spirit of the invention.

1. A trailer for towing motorized vehicles behind a tow vehicle, said trailer comprising:
an undercarriage having a forward end and a rear end;
at least one axle on said undercarriage for mounting of wheels for supporting said undercarriage;
an attachment mechanism extending from said forward end of said undercarriage for attaching said trailer behind said tow vehicle; and
first and second independently displaceable bed sections mounted longitudinally adjacent to one another on said undercarriage, each of said bed sections being displaceable away from each other towards respective sides of said undercarriage, said bed sections having a forward end that displaces substantially outwardly towards said respective sides so as to allow sufficient clearance from said tow vehicle, allowing said motorized vehicles to be offloaded in a forward direction.

2. The trailer according to claim 1, wherein said rear end of said undercarriage comprises a plurality of mounting holes for placement of a removable loading ramp.

3. The trailer according to claim 1, wherein the forward end of each of said bed sections is provided with a front ramp assembly.

4. The trailer according to claim 3, wherein said front ramp assembly is hinged to said bed section, said front ramp assembly being movable from a first stowed position to a second deployed position.

5. The trailer according to claim 1, wherein each of said bed sections comprises a platform supported by an open lattice frame.

6. The trailer according to claim 1, wherein each of said bed sections is configured with a cutout along adjacent inside and rear edges so as to allow unrestricted movement of each bed section relative to one another.

7. The trailer according to claim 6, wherein said cutout is a radiused curve.

8. The trailer according to claim 6, wherein said cutout is an angular cutout.

9. The trailer according to claim 1, wherein each of said bed sections is provided with an outside railing.

10. The trailer according to claim 1, wherein a locking mechanism is provided for each said bed section to prevent displacement relative to said undercarriage.

11. The trailer according to claim 10, wherein said locking mechanism is a pin that extends through said bed section for registration into a corresponding recess in said undercarriage.

12. The trailer according to claim 1, wherein each of said bed sections is pivotally attached to said undercarriage at respective pivot points located towards said rear end of said undercarriage.

13. The trailer according to claim 12, wherein each of said respective pivot points is provided with a friction reducer to facilitate pivotal movement of said bed sections relative to said undercarriage.

14. The trailer according to claim 13, wherein said friction reducer comprises grease placed between mating surfaces of said bed sections and said undercarriage.

15. The trailer according to claim 13, wherein said friction reducer is a low friction washer.

16. The trailer according to claim 13, wherein said friction reducer is a suitable bearing assembly.

17. The trailer according to claim 1, wherein each of said bed sections is displaced relative to said undercarriage using hydraulic cylinders.

18. The trailer according to claim 1, wherein an arced track assembly is used to guide each of said bed sections from a first stowed position to a second deployed position.

19. The trailer according to claim 1, wherein a low friction material or a plurality of ball races are positioned between said displaceable bed sections and said undercarriage so as to facilitate operation of said trailer.

20. The trailer according to claim 1, wherein displacement of each of said bed sections is mechanically actuated by way of a crank or motorized assembly.
